(19) United States
(12) Patent Application Publication
(10) Pub. No.: US 2026/0065413 A1
(43) Pub. Date: Mar. 5, 2026

(54) Interpolation Scheme for Warping Image with Missing Pixel Data

(71) Applicant: Zebra Technologies Corporation, Lincolnshire, IL (US)

(72) Inventors: Ola El Bakry, Dollard-Des-Ormeaux (CA); Jean-Sébastien Lemieux, Montréal (CA)

(21) Appl. No.: 18/821,562

(22) Filed: Aug. 30, 2024

(51) Int. Cl. G06T 3/18

(52) U.S. Cl. CPC G06T 3/18

(57) ABSTRACT

A method and system for performing image warping of images having missing pixel data. The method includes obtaining, by a first imaging assembly having a first field of view, a first image of one or more objects in the first field of view. The first image has one or more pixels with missing data pixel values. A processor determines a mapped pixel location for each pixel of the first image. The processor then identifies a pixel neighborhood having a pixel neighborhood configuration for each mapped pixel location. The processor further determines a mapped pixel value for each mapped pixel, each mapped pixel value based on the pixel neighborhood configuration. The warped image of mapped pixels and mapped pixel values is then presented to a user.

### BACKGROUND

Industrial scanners and/or barcode readers may be used in warehouse environments and/or other environments and may be provided in the form of mobile scanning devices. These scanners may be used to scan or image barcodes, packages, and other objects. In shipping, and in storage rooms and warehouse settings, scanning and imaging of parcels and objects is used for identifying objects, performing post fabrication analysis, and quality assurance purposes among other applications. Often, three-dimensional (3D) cameras and imaging systems are used to perform such operations, which can result in missing pixel data due to parts of an object being out of a field of view, other obstructions in the field of view, bad camera sensor pixels, etc. Therefore, such image capture systems have limitations in determining surface features and dimensions which can be integral in performing desired operations. Further, many objects may be too large for a single camera to capture, and missing data must be filled in using a second imaging assembly. As such, images having missing data may be combined, resulting in compounded errors, or determining incorrect estimated values for missing data pixels, resulting in reduced scanning and object identification efficiencies, or further requiring manual inspection and operation.

Accordingly, there is a need for improved designs having improved functionalities.

### SUMMARY

In accordance with a first embodiment, the present invention is a method for performing image warping. The method includes obtaining, by a first imaging assembly having a first field of view, a first image of one or more objects in the first field of view, the first image including one or more pixels having missing data pixel values; determining, by the processor, a mapped pixel location for each pixel of the first image;

identifying, by the processor, a pixel neighborhood having a pixel neighborhood configuration for each mapped pixel location; determining, by the processor, a mapped pixel value for each mapped pixel, each mapped pixel value based on the pixel neighborhood configuration; and presenting an image of the mapped pixels and mapped pixel values to a user.

In a variation of the current embodiment, each mapped pixel value is determined as one of (i) an interpolation of pixel values in the pixel neighborhood, (ii) an extrapolation of pixel values in the pixel neighborhood, or (iii) a missing data pixel value, based on the pixel neighborhood configuration. In continued variations, the mapped pixel location of each mapped pixel is a sub-pixel location of a respective pixel neighborhood for each pixel, and/or the mapped pixel value is further determined based on the sub-pixel position of each mapped pixel in each respective pixel neighborhood.

In more variations of the current embodiment, the method further includes obtaining, by a second imaging assembly having a second field of view, a second image of one or more objects in the second field of view; determining, by the processor, a mapped pixel location for each pixel of the second image; identifying, by the processor, a pixel neighborhood having a pixel neighborhood configuration for each mapped pixel location; and determining, by the processor, a mapped pixel value for each mapped pixel, each mapped pixel value based on the pixel neighborhood configuration. In such variations, the method may further include transforming, by a processor, the second image according to the first field of view of the first imaging assembly to generate a transformed second image.

In any variations, the first imaging assembly, and/or second imaging assembly, may include a two-dimensional, or three-dimensional camera.

In another embodiment, the present invention is a system for performing image warping. The system includes a first imaging assembly having an imaging sensor configured to capture images of a first field of view; and one or more processors and machine readable instructions that when executed by the one or more processors cause the system to: obtain a first image by the first imaging assembly of one or more objects in the first field of view, the first image including one or more pixels having missing pixel data, determine a mapped pixel location for each pixel of the first image, identify a pixel neighborhood having a pixel neighborhood configuration for each mapped pixel location, determine a mapped pixel value for each mapped pixel, each mapped pixel value based on the pixel neighborhood configuration, and present an image of the mapped pixels and mapped pixel values to a user.

In variations of the current embodiment, the mapped pixel value is determined as one of (i) an interpolation of pixel values in the pixel neighborhood, (ii) an extrapolation of pixel values in the pixel neighborhood, or (iii) a missing data pixel value, based on the pixel neighborhood configuration. In more variations, the mapped pixel location of each mapped pixel is a sub-pixel location of a respective pixel neighborhood for each pixel. In continued variations, each mapped pixel value is further determined based on the sub-pixel position of each mapped pixel in each respective pixel neighborhood.

In additional variations, the system further includes a second imaging assembly having an imaging sensor configured to capture images of a second field of view, and wherein the machine readable instructions, when executed by the one or more processors, further cause the system to: obtain a second image by the second imaging assembly of one or more objects in the second field of view, determine a mapped pixel location for each pixel of the second image, identify a pixel neighborhood having a pixel neighborhood configuration for each mapped pixel location of the second image, and determine a mapped pixel value for each mapped pixel of the second image, each mapped pixel value based on each respective pixel neighborhood configuration. In such variations, the machine readable instructions, when executed by the one or more processors, may further cause the system to transform the second image according to the first field of view of the first imaging assembly to generate a transformed second image.

In any variations, the first imaging assembly, and/or second imaging assembly, may include a two-dimensional, or three-dimensional camera.

In yet another embodiment, the present invention is one or more non-transitory computer-readable media storing computer-executable instructions that, when executed via one or more processors, cause one or more systems to: obtain a first image of one or more objects in a first field of view, the first image including one or more pixels having missing pixel data; determine a mapped pixel location for each pixel of the first image; identify a pixel neighborhood having a pixel neighborhood configuration for each mapped pixel location; determine a mapped pixel value for each mapped pixel, each mapped pixel value based on the pixel neighborhood configuration; and present an image of the mapped pixels and mapped pixel values to a user.

In variations of the current embodiment, the mapped pixel location of each mapped pixel is a sub-pixel location of a respective pixel neighborhood for each pixel. In more variations, each mapped pixel value is further determined based on the sub-pixel position of each mapped pixel in each respective pixel neighborhood. In any variations of the current embodiment, the first imaging assembly, and/or second imaging assembly, may include a two-dimensional, or three-dimensional camera.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of an example imaging system configured to analyze an image of a target object to execute a machine vision task, in accordance with various embodiments disclosed herein.

FIG. 2 is a side view block diagram of a first embodiment of the imaging device of FIG. 1, in accordance with embodiments described herein.

FIG. 3 is a perspective view of a second embodiment of the imaging device of FIG. 1 that may be implemented in accordance with embodiments described herein.

FIG. 4A is illustrative of an example environment with an imaging device fixed at a position relative to target objects for obtaining images of the target objects to perform image warping and data reconstruction as described herein.

FIG. 4B is illustrative of an example environment with two imaging devices fixed at different positions relative to target objects for obtaining images of the target objects to perform image warping and data reconstruction as described herein.

FIG. 5 is a flowchart of a method for performing image warping and data reconstruction.

FIG. 6 is a flowchart of a method for performing image warping and data reconstruction with two images, and transforming one image into the perspective of the other image.

FIG. 7 is an example image and warped image including a plurality of pixels with pixel neighborhoods and mapped pixel values derived according to the methods described herein.

FIG. 8 is an example pixel neighborhood of four pixels with each pixel having image data.

FIG. 9A provides four different neighborhood configurations each with one of four pixels missing data.

FIG. 9B illustrates different sub-regions for determining a mapped pixel value for pixel neighborhood configurations having one missing pixel value.

FIG. 9C provides example images of pixel neighborhoods that include one pixel having missing data, and further provides corresponding mapped pixels with pixel values derived from data of respective pixel neighborhoods.

FIG. 10A provides illustrations of four pixel neighborhood configurations each including two pixels with missing data.

FIG. 10B provides illustrations of different sub-regions of a pixel neighborhood for determining mapped pixel values.

FIG. 10C provides example images with pixel neighborhoods having two pixels with missing data, and associated warped images with mapped pixels showing reconstructed data using the sub-pixel locations of the pixel neighborhoods.

FIG. 11A provides illustrations of two different pixel neighborhood configurations with two pixels having missing data that are diagonally opposite each other in the pixel neighborhood.

FIG. 11B provides one example of various sub-regions of a pixel neighborhood that may be used to determine mapped pixel values.

FIG. 11C provides example images with pixel neighborhoods used to determine mapped data pixel values, and further provides corresponding mapped pixels with pixel values derived from respective pixel neighborhoods.

FIG. 12A provides illustrations of four different pixel neighborhood configurations having three pixels with missing data.

FIG. 12B provides one example of sub-regions of a pixel neighborhood for determining mapped pixel values.

FIG. 12C provides images with pixel neighborhood configurations with three pixels having missing data, and respective mapped pixels with pixel data determined from the pixel neighborhoods according to the methods described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally, pursuant to these various embodiments, a method and system is provided that may provide or fill-in data for images having missing image data. In examples, captured three-dimensional (3D), or two-dimensional (2D) images may include pixels having missing data due to the inability to image a region, a camera having dead pixels, or another reason. For the methods and systems described herein, the images are processed and replacement data for the missing pixel, or voxel, data is interpolated or extrapolated based on specific profiles of neighborhood of pixels around the missing pixel or voxel. The method uses sub-pixel locations to determine the neighborhoods used for the missing pixel data. The method determines different interpolation or extrapolation boundaries and regions for filling in the missing pixel data based on specific pixel data configurations in the neighborhoods. The described methods and systems may be used for warping images such as for mapping one image to a different cameras field of view, for overlapping images, for patching images together etc. Other techniques for warping images for various applications often leads to increasing the number of pixels having missing data, while the described methods allow for decreasing the number of missing data pixels during image manipulation and warping.

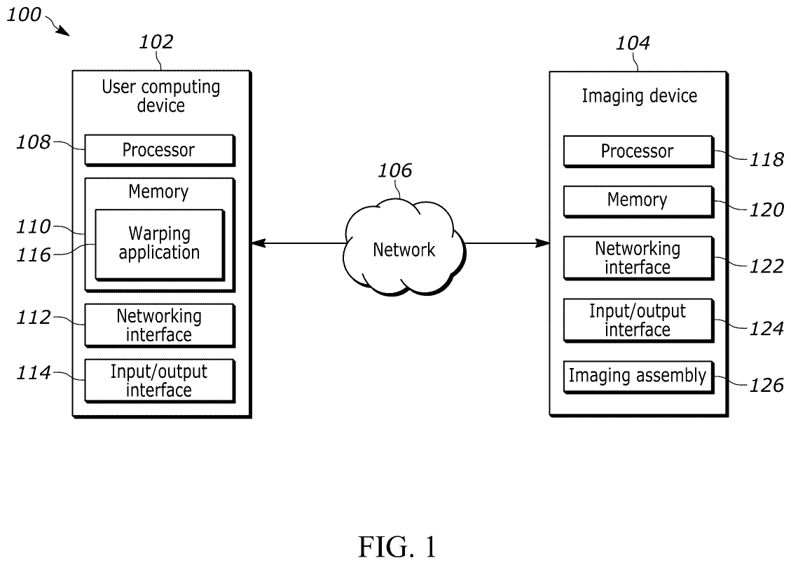

FIG. 1 illustrates an example imaging system 100 configured to analyze an image of a target object to execute a machine vision task, in accordance with various embodiments disclosed herein. Machine vision may also be referred to as computer vision for the systems and methods described herein. The imaging system 100 is configured to capture images of objects, perform image warping, and fill in missing data for pixels of the captured images. The system 100 may be used for performing object recognition, part and fabrication inspection, inventory analysis, etc. In the example embodiment of FIG. 1, the imaging system 100 includes a user computing device 102 and an imaging device 104 communicatively coupled via a network 106. The user computing device 102 may include one or more processors 108, one or more memories 110, a networking interface 112, an input/output (I/O) interface 114, and a warping application 116. The user computing device 102 and the imaging device 104 may be capable of executing instructions to, for example, implement operations of the example methods described herein, as may be represented by the flowcharts of the drawings that accompany this description. The user computing device 102 is generally configured to enable a user/operator to create a machine vision task for execution on the imaging device 104. In examples, the imaging device 104 may utilize machine vision techniques to analyze captured images and execute a task. In other examples, the imaging device 104 may capture images and provide the images to another device such as a network, or processor, that may analyze the images and perform a machine vision task for image processing. When created, the user/operator may then transmit/upload the machine vision task to the imaging device 104 via the network 106, where the machine vision task is then interpreted and executed.

The imaging device 104 is connected to the user computing device 102 via a network 106, and is configured to interpret and execute tasks received from the user computing device 102. Generally, the imaging device 104 may obtain a task file containing one or more task scripts from the user computing device 102 across the network 106 that may define the machine vision task and may configure the imaging device 104 to capture and/or analyze images in accordance with the task. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture an image of the target object in accordance with the configuration established via the one or more task scripts. Once captured and/or analyzed, the imaging device 104 may transmit the images and any associated data across the network 106 to the user computing device 102 for further analysis and/or storage. In various embodiments, the imaging device 104 may be a “smart” camera and/or may otherwise be configured to automatically obtain, interpret, and execute task scripts that define machine vision tasks, such as any one or more task scripts contained in one or more task files as obtained, for example, from the user computing device 102. In examples, the imaging device 104 may be a handheld device that a user controls to capture one or more images of a target at one or more perspectives of the target for further processing of the images and for reconstruction of one or more features or dimensions of the target.

Broadly, the task file may be a JSON representation/data format of the one or more task scripts transferrable from the user computing device 102 to the imaging device 104. The task file may further be loadable/readable by a C++ runtime engine, or other suitable runtime engine, executing on the imaging device 104. Moreover, the imaging device 104 may run a server (not shown) configured to receive task files across the network 106 from the user computing device 102. Additionally or alternatively, the server configured to receive task files may be implemented as one or more cloud-based servers, such as a cloud-based computing platform. For example, the server may be any one or more cloud-based platform(s) such as MICROSOFT AZURE, AMAZON AWS, or the like.

The imaging device 104 may include one or more processors 118, one or more memories 120, a networking interface 122, an I/O interface 124, and an imaging assembly 126. The imaging assembly 126 may include a digital camera and/or digital video camera for capturing or taking digital images and/or frames. Each digital image may comprise pixel data, voxel data, vector information, or other image data that may be analyzed by one or more tools each configured to perform an image analysis task. The digital camera and/or digital video camera of, e.g., the imaging assembly 126 may be configured, as disclosed herein, to take, capture, obtain, or otherwise generate digital images and, at least in some embodiments, may store such images in a memory (e.g., one or more memories 110, 120) of a respective device (e.g., user computing device 102, imaging device 104).

For example, the imaging assembly 126 may include a photo-realistic camera (not shown) for capturing, sensing, or scanning 2D image data. The photo-realistic camera may be a red, green blue (RGB) based camera for capturing 2D images having RGB-based pixel data. In various embodiments, the imaging assembly may additionally include a 3D camera (not shown) for capturing, sensing, or scanning 3D image data. The 3D camera may include an Infra-Red (IR) projector and a related IR camera for capturing, sensing, or scanning 3D image data/datasets. Other 3D cameras may be used for the described methods such as projectors, lasers, time of flight sensors and systems, and/or structured light based detection systems, among other systems and devices capable of capturing 3D data from one or more FsOV. In some embodiments, the photo-realistic camera of the imaging assembly 126 may capture 2D images, and related 2D image data, at the same or similar point in time as the 3D camera of the imaging assembly 126 such that the imaging device 104 can have both sets of 3D image data and 2D image data available for a particular surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. As such, the captured 2D images and the corresponding 2D image data may be depth-aligned with the 3D images and 3D image data.

In embodiments, the imaging assembly 126 may be configured to capture images of surfaces or areas of a predefined search space or target objects within the predefined search space. For example, each tool included in a task script may additionally include a region of interest (ROI) corresponding to a specific region or a target object imaged by the imaging assembly 126. The ROI may be a predefined ROI, or the ROI may be determined through analysis of the image by the processor 118. Further, a plurality of ROIs may be predefined or determined through image processing. The composite area defined by the ROIs for all tools included in a particular task script may thereby define the predefined search space which the imaging assembly 126 may capture to facilitate the execution of the task script. However, the predefined search space may be user-specified to include a field of view (FOV) featuring more or less than the composite area defined by the ROIs of all tools included in the particular task script. The imaging assembly 126 may be configured to identify predefined objects or physical features for reconstruction of a target or dimensions of a target. For example, the imaging assembly 126 may be configured to identify a cuboid, or features of a cuboid (e.g., vertices, edge lines, surfaces, etc.) of a box or parcel for further processing to determine a size or other dimension of one or more features of the cuboid.

It should be noted that the imaging assembly 126 may capture 2D and/or 3D image data/datasets of a variety of areas, such that additional areas in addition to the predefined search spaces are contemplated herein. Moreover, in various embodiments, the imaging assembly 126 may be configured to capture other sets of image data in addition to the 2D/3D image data, such as grayscale image data or amplitude image data, each of which may be depth-aligned with the 2D/3D image data. Further, one or more ROIs may be within a FOV of the imaging system such that any region of the FOV of the imaging system may be a ROI. In examples, the imaging assembly 126 may include more than one imaging sensor or camera having different FsOV. As such, the imaging assembly 126, the processor 118, or another processor (such as the processor 108) may perform warping of images to generate a composite image or patch images together. In examples, the images, and warped images, may include one or more pixels having missing data. The described methods may then provide data for the pixels having missing data to improve the performance of machine vision, object identification, and other applications as described herein.

The imaging device 104 may also process the 2D image data/datasets and/or 3D image datasets for use by other devices (e.g., the user computing device 102, an external server). For example, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. The image data and/or the post-imaging data may be sent to the user computing device 102 executing the warping application 116 for viewing, processing, and/or otherwise interaction. In other embodiments, the image data and/or the post-imaging data may be sent to a server for storage or for further manipulation. As described herein, the user computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

Each of the one or more memories 110, 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., warping application 116, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 120) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

The one or more memories 110, 120 may store an operating system (OS) (e.g., Microsoft Windows, Linux, Unix, etc.) capable of facilitating the functionalities, apps, methods, or other software as discussed herein. The one or more memories 110 may also store the warping application 116, which may be configured to enable machine vision task construction, as described further herein. Additionally, or alternatively, the warping application 116 may also be stored in the one or more memories 120 of the imaging device 104, and/or in an external database (not shown), which is accessible or otherwise communicatively coupled to the user computing device 102 via the network 106. The one or more memories 110, 120 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision based imaging application, such as the warping application 116, where each may be configured to facilitate their various functionalities discussed herein. It should be appreciated that one or more other applications may be envisioned and may be executed by the one or more processors 108, 118.

The one or more processors 108, 118 may be connected to the one or more memories 110, 120 via a computer bus responsible for transmitting electronic data, data packets, or otherwise electronic signals to and from the one or more processors 108, 118 and one or more memories 110, 120 to implement or perform the machine readable instructions, methods, processes, elements or limitations, as illustrated, depicted, or described for the various flowcharts, illustrations, diagrams, figures, and/or other disclosure herein.

The one or more processors 108, 118 may interface with the one or more memories 110, 120 via the computer bus to execute the operating system (OS). The one or more processors 108, 118 may also interface with the one or more memories 110, 120 via the computer bus to create, read, update, delete, or otherwise access or interact with the data stored in the one or more memories 110, 120 and/or external databases (e.g., a relational database, such as Oracle, DB2, MySQL, or a NoSQL based database, such as MongoDB). The data stored in the one or more memories 110, 120 and/or an external database may include all or part of any of the data or information described herein, including, for example, machine vision task images (e.g., images captured by the imaging device 104 in response to execution of a task script) and/or other suitable information.

The networking interfaces 112, 122 may be configured to communicate (e.g., send and receive) data via one or more external/network port(s) to one or more networks or local terminals, such as network 106, described herein. In some embodiments, networking interfaces 112, 122 may include a client-server platform technology such as ASP.NET, Java J2EE, Ruby on Rails, Node.js, a web service or online API, responsive for receiving and responding to electronic requests. The networking interfaces 112, 122 may implement the client-server platform technology that may interact, via the computer bus, with the one or more memories 110, 120 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally or alternatively, network 106 may comprise a public network such as the Internet. In some embodiments, the network 106 may comprise routers, wireless switches, or other such wireless connection points communicating to the user computing device 102 (via the networking interface 112) and the imaging device 104 (via networking interface 122) via wireless communications based on any one or more of various wireless standards, including by non-limiting example, IEEE 802.11a/b/c/g (WIFI), the BLUETOOTH standard, or the like.

The I/O interfaces 114, 124 may include or implement operator interfaces configured to present information to an administrator or operator and/or receive inputs from the administrator or operator. An operator interface may provide a display screen (e.g., via the user computing device 102 and/or imaging device 104) which a user/operator may use to visualize any images, graphics, text, data, features, pixels, and/or other suitable visualizations or information. For example, the user computing device 102 and/or imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user computing device 102 and/or the imaging device 104. According to some embodiments, an administrator or user/operator may access the user computing device 102 and/or imaging device 104 to construct tasks, review images or other information, make changes, input responses and/or selections, and/or perform other functions.

As described above herein, in some embodiments, the user computing device 102 may perform the functionalities as discussed herein as part of a “cloud” network or may otherwise communicate with other hardware or software components within the cloud to send, retrieve, or otherwise analyze data or information described herein.

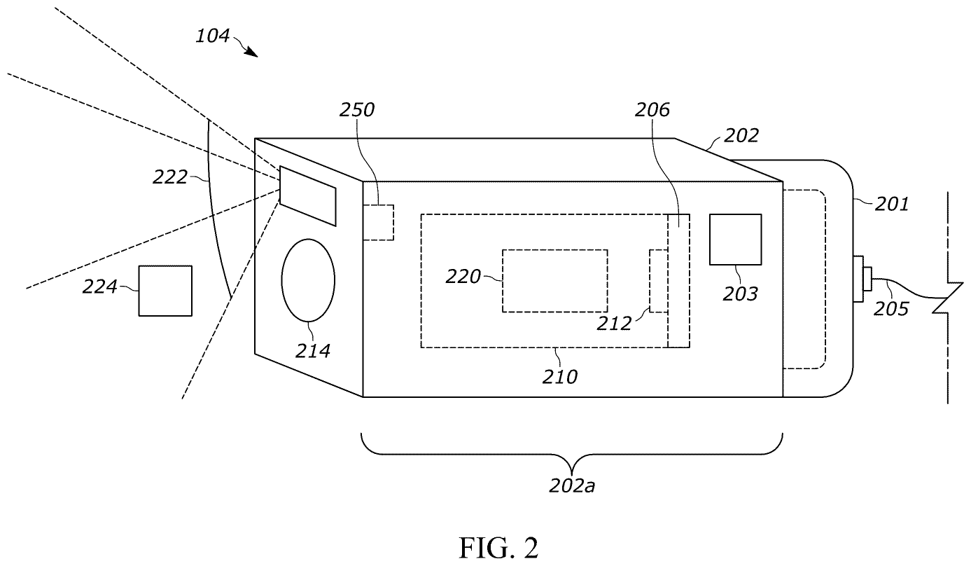

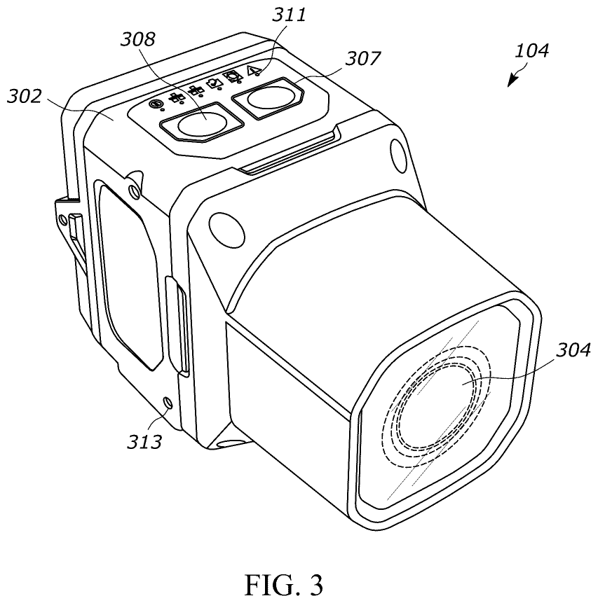

Two embodiments of imaging devices for performing image warping and data reconstruction, as described herein, are shown in schematics in FIGS. 2-3. Referring now to FIG. 2, the imaging device 104 includes a housing 202, an illumination system 250, and an imaging system 210 at least partially disposed within the housing 202 that includes an imaging camera assembly. Specifically, the imaging system 210 includes an image sensor 212 and a lens assembly 220. The device 104 may be adapted to be inserted into a docking station 201 which, in some examples, may include an AC power source 205 to provide power for the device 104. The device 104 may further include an onboard power supply 203, such as a battery and a printed circuit board 206 that may accommodate a memory and a controller that controls operation of the imaging system 210. In embodiments, the device 104 may include a trigger (not shown in the illustration) that is used to activate the imaging system 210 to capture an image. The device 104 may include any number of additional components such as decoding systems, processors, and/or circuitry coupled to the circuit board 206 to assist in operation of the device 104.

The housing 202 includes a forward or reading head portion 202a which supports the imaging system 210 within an interior region of the housing 202. The imaging system 210 may, but does not have to be, modular as it may be removed or inserted as a unit into the devices, allowing the ready substitution of illumination systems 250 and/or imaging systems 210 having different illumination and/or imaging characteristics (e.g., illumination systems having different illumination sources, lenses, illumination filters, illumination FOVs and ranges of FOVs, camera assemblies having different focal distances, working ranges, and imaging FOVs) for use in different devices and systems. In some examples, the field of view may be static.

The image sensor 212 may have a plurality of photosensitive elements forming a substantially flat surface and may be fixedly mounted relative to the housing 202 using any number of components and/or approaches. The image sensor 212 further has a defined central imaging axis, A, that is normal to the substantially flat surface. In some embodiments, the imaging axis A is coaxial with a central axis of the lens assembly 220. The lens assembly 220 may also be fixedly mounted relative to the housing 202 using any number of components and/or approaches. In the illustrated embodiment, the lens assembly 220 is positioned between a front aperture 214 and the image sensor 212. The front aperture 214 blocks light from objects outside of the field of view which reduces imaging problems due to stray light from objects other than the target object. Additionally, the front aperture 214 in conjunction with a one or more lenses allows for the image to form correctly on the imaging sensor 212.

The housing 202 includes an illumination system 250 configured to illuminate a target object of interest for imaging of the target. The target may be a 1D barcode, 2D barcode, QR code, Universal Product Code (UPC) code, or another indicia indicative of the object of interest such as alphanumeric characters or other indicia. Additionally, the target may include one or more boxes, vehicles, rooms, containers, objects, or cuboid parcels, and the imaging system 250 may be configured to capture a color image or infrared image of the one or more targets. The illumination system 250 may provide illumination to an illumination FOV 222 to enable or assist with imaging a target 224.

FIG. 3 is a perspective view of a second embodiment of an imaging device 104 that may be implemented in accordance with embodiments described herein. The imaging device 104 includes a housing 302, an imaging aperture 304, a user interface label 307, a dome switch/button 308, one or more light emitting diodes (LEDs) 311, and mounting point(s) 313. As previously mentioned, the imaging device 104 may obtain task files from a user computing device (e.g., user computing device 102) which the imaging device 104 thereafter interprets and executes. The instructions included in the task file may include device configuration settings (also referenced herein as “imaging settings”) operable to adjust the configuration of the imaging device 104 prior to capturing images of a target object.

For example, the device configuration settings may include instructions to adjust one or more settings related to the imaging aperture 304. As an example, assume that at least a portion of the intended analysis corresponding to a machine vision task requires the imaging device 104 to maximize the brightness of any captured image. To accommodate this requirement, the task file may include device configuration settings to increase the aperture size of the imaging aperture 304. The imaging device 104 may interpret these instructions (e.g., via one or more processors 118) and accordingly increase the aperture size of the imaging aperture 304. Thus, the imaging device 104 may be configured to automatically adjust its own configuration to optimally conform to a particular machine vision task. Additionally, the imaging device 104 may include or otherwise be adaptable to include, for example but without limitation, one or more bandpass filters, one or more polarizers, one or more waveplates, one or more DPM diffusers, one or more C-mount lenses, and/or one or more C-mount liquid lenses over or otherwise influencing the received illumination through the imaging aperture 304.

The user interface label 307 may include the dome switch/button 308 and one or more LEDs 311, and may thereby enable a variety of interactive and/or indicative features. Generally, the user interface label 307 may enable a user to trigger and/or tune the imaging device 104 (e.g., via the dome switch/button 308) and to recognize when one or more functions, errors, and/or other actions have been performed or taken place with respect to the imaging device 104 (e.g., via the one or more LEDs 311). For example, the trigger function of a dome switch/button (e.g., dome/switch button 308) may enable a user to capture an image using the imaging device 104 and/or to display a trigger configuration screen of a user application (e.g., warping application 116). The trigger configuration screen may allow the user to configure one or more triggers for the imaging device 104 that may be stored in memory (e.g., one or more memories 110, 120) for use in later developed machine vision tasks, as discussed herein. The imaging device 104 may be a portable imaging device that a user may move around a target to obtain images at different perspectives of the target. The different perspectives may be considered to be taken at different fields of view of the imaging device 104. The imaging device 104 may have a single field of view but the perspective of the target may change based on the position and orientation of the imaging device 104 and corresponding field of view. In examples, a system may employ an imaging device having multiple fields of view with each field of view having a different spatial perspective of a target. As such, the imaging device may obtain multiple images of the target at different perspectives corresponding to the different fields of view of the imaging device. In more examples, a system may employ multiple imaging devices 104 with each imaging device 104 having a respective field of view with each field of view having a different perspective of a target. Therefore, each of the imaging devices may obtain an image at a different perspective for performing the methods described herein.

As another example, the tuning function of a dome switch/button (e.g., dome/switch button 308) may enable a user to automatically and/or manually adjust the configuration of the imaging device 104 in accordance with a preferred/predetermined configuration and/or to display an imaging configuration screen of a user application (e.g., warping application 116). The imaging configuration screen may allow the user to configure one or more configurations of the imaging device 104 (e.g., aperture size, exposure length, etc.) that may be stored in memory (e.g., one or more memories 110, 120) for use in later developed machine vision tasks, as discussed herein.

To further this example, and as discussed further herein, a user may utilize the imaging configuration screen (or more generally, the warping application 116) to establish two or more configurations of imaging settings for the imaging device 104. The user may then save these two or more configurations of imaging settings as part of a machine vision task that is then transmitted to the imaging device 104 in a task file containing one or more task scripts. The one or more task scripts may then instruct the imaging device 104 processors (e.g., one or more processors 118) to automatically and sequentially adjust the imaging settings of the imaging device 104 in accordance with one or more of the two or more configurations of imaging settings after each successive image capture.

The mounting point(s) 313 may enable a user connecting and/or removably affixing the imaging device 104 to a mounting device (e.g., imaging tripod, camera mount, etc.), a structural surface (e.g., a warehouse wall, a warehouse ceiling, scanning bed or table, structural support beam, etc.), other accessory items, and/or any other suitable connecting devices, structures, or surfaces. For example, the imaging device 104 may be optimally placed on a mounting device in a distribution center, manufacturing plant, warehouse, and/or other facility to image and thereby monitor the quality/consistency of products, packages, and/or other items as they pass through the imaging device's 104 FOV. Moreover, the mounting point(s) 313 may enable a user to connect the imaging device 104 to a myriad of accessory items including, but without limitation, one or more external illumination devices, one or more mounting devices/brackets, and the like.

In addition, the imaging device 104 may include several hardware components contained within the housing 302 that enable connectivity to a computer network (e.g., network 106). For example, the imaging device 104 may include a networking interface (e.g., networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, RS-232, and/or any other suitable communication protocol or combinations thereof.

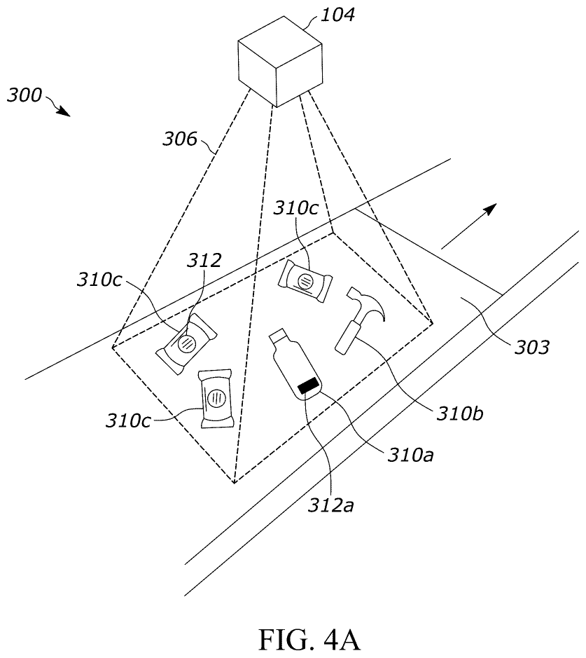

FIG. 4A is illustrative of an example environment 400 for performing warping and data reconstruction of images as described herein. In the environment 300 of FIG. 3 the imaging device 104 of FIGS. 1 and 2 is position above a scanning surface 303. The imaging device 104 is disposed and oriented such that a field of view (FOV) 306 of the imaging device 104 includes a portion of the scanning surface 303. The scanning surface may be a table, podium, mount for mounting an object or part, a conveyer, a cubby hole, or another mount or surface that may support a part or object to be scanned. As illustrated, the scanning surface 303 is a conveyer belt having a plurality of objects of interest 310a, 310b, and 310c thereon. The objects of interested 310a-310c are illustrated as being within the FOV 306 of the imaging device 104. The objects of interest 310a-310c may contain indicia 312 thereon. The imaging device 104 captures one or more images of the objects of interest 310a-310c and may determine a region of interest within the image that contains the objects of interest 310a-310c, or the ROI may be determined as a region of the image that contains the indicia 312. As illustrated, the indicia 312 may be a barcode, but the indicia 312 may include one or more of 1D barcode, 2D barcode, QR code, static barcode, dynamic barcode, alphabetical character, text, numerals, alphanumeric, other characters, a picture, vehicle identification number, expiration date, tire identification number, or another indicia having characters and/or numerals. In examples, the objects of interest 310a-310c may have more than one indicia, and the imaging device 104 may capture an image of the FOV 306 and determine multiple ROIs in the captured image, each ROI having at least one indicia for decoding. In examples, the ROI may include one or more of the objects of interest 310a-310c.

The imaging device 104 may capture 2D or 3D images of the objects of interest 310a-310c, and the images may include pixels or voxels with missing data. For example, some objects may overlap portions of other objects, or a physical feature of an object may obscure another part of itself that may be required, or may provide data, that may be used for performing machine vision operations. As such, the imaging device 104, or another processor or system, may perform warping and data reconstruction to generate images of the objects of interest 310a-310c that include reconstructed 2D or 3D image data to perform machine vision operations.

The imaging device 104 may be mounted above the object of interest 310 on a ceiling, a beam, a metal tripod, or another object for supporting the position of the imaging device 104 for capturing images of the scanning surface 303. Further, the imaging device 104 may alternatively be mounted on a wall or another mount that faces objects on the scanning surface 303 from a horizontal direction. In examples, the imaging device 104 may be mounted on any apparatus or surface for imaging and scanning objects of interest that are in, or pass through, the FOV 306 of the imaging device 104.

FIG. 4B is illustrative of an example environment 400 with two imaging devices 104a and 104b fixed at two positions relative to a scanning surface 303 for obtaining multiple images of the objects of interest 310a-310c to perform image warping and data reconstruction as described herein. In the environment 400 of FIG. 4B the imaging devices 104a and 104b are positioned above at different relative angles from the scanning surface 303. In implementation, the imaging devices may include one or more of the devices 104 illustrated in FIGS. 2 and 3, or may be another imaging device. As FIG. 4B illustrates, the imaging devices 104a and 104b may be disposed and oriented such that fields of view (FOVs) 306a and 306b of the imaging devices 104a and 104b include a portion of the scanning surface 303. The scanning surface 303 may be a table, podium, mount for mounting an object or part, a conveyer, a cubby hole, or another mount or surface that may support a part or object to be scanned. As illustrated, the scanning surface 303 is a conveyer belt having objects of interest 310a-310c thereon. The objects of interest 310a-310c are illustrated as being within the FOVs 306a and 306b of the imaging devices 104a and 104b.

In examples, each of the imaging devices 104a and 104b captures one or more images at different physical perspectives, with each of the imaging devices 104a and 104b having different FOVs of the object of interest 410. In such examples, a processor may warp one of the images captured by the imaging devices to map the image to the FOV of the other imaging device. In examples, the FOV mapping transformation may be known, or features of the scanning surface 303 and/or objects of interest 110a-110c may be used to determine the required mapping between the FsOV of the imaging devices 104a and 104b. The imaging devices 104a and 104b may be mounted above or around the object of interest 410 on a ceiling, a beam, a metal tripod, or another object for supporting the position of the imaging devices 104a and 104b for capturing images of the scanning bed 403 and objects disposed thereon. Further, the imaging devices 104a and 104b may alternatively be mounted on a wall or another mount that faces objects on the scanning bed 403 from a horizontal direction. In examples, the imaging devices 104a and 104b may be mounted on any apparatus or surface for imaging and scanning objects of interest that are in, or pass through, the FOVs 406a and 406b of the imaging devices 104a and 104b.

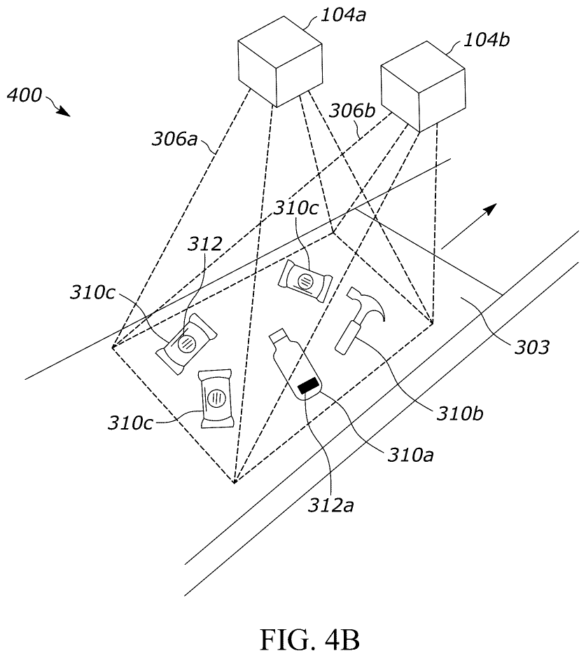

FIG. 5 is a flowchart of a method 500 for performing data reconstructive image warping, as may be performed entirely or as part of the warping application of FIG. 1. The method 500 includes capturing a first image of a first FOV at 502. The first image may be captured by an imaging system including an imaging device such as the imaging devices 104 of FIGS. 2 and 3, or by another camera or imaging device or system. The imaging device captures an image of a FOV of the imaging device 104, with one or more targets, or objects of interest, being disposed in the FOV of the imaging device. In examples, the imaging system may include one or more of an infrared camera, a color camera, two-dimensional camera, a three-dimensional camera, a handheld camera, or a plurality of cameras.

The method then includes determining, by a processor such as the processor 118 of the imaging device 104 of FIG. 1, or the processor 108 of the computing device 102, a mapped pixel location for each pixel of the first image at 504. The mapped pixel location may be different for different warping processes. For example, the processor may perform an image stretch in one or more dimensions that result in determining corresponding mapped pixel locations for each pixel of the original first image, and different mapped pixel locations may be determined for the processor performing an image skewing or rotation.

The processor then determines a pixel neighborhood in the first image to determine a pixel value for the mapped pixel location in the warped image at 506. As described herein, the pixel neighborhood may include four pixels in the first image that correspond to the mapped pixel location in the warped image. The pixel neighborhood may be determined from a specific transformation being performed such as a scaling, rotation, mapping, etc. Given a transformation of the first image to a mapped image, the inverse transformation of a pixel in the mapped image gives a pixel location in the original image. The pixel location in the first image, as determined by inverse transformations of mapped pixel locations from a warped image to the first image, is generally a sub-pixel location. This sub-pixel location lies in-between four pixels, thus, as described further herein, four neighboring pixels will be used to determine a mapped pixel data value from such a sub-pixel location, and specifically to determine the mapped pixel value as an interpolation, extrapolation, or invalid or missing value. Each pixel neighborhood is used to determine the value of one or more mapped pixels, and for performing data reconstruction of pixels having missing data, in performing warping of images. While described herein as being a neighborhood of four pixels, the pixel neighborhoods may include more pixels such as a 3 by 3 grouping of 9 pixels, or more. The use of a 2 by 2 neighborhood of four pixels is used herein for clarity and simplicity of demonstrating the described methods.

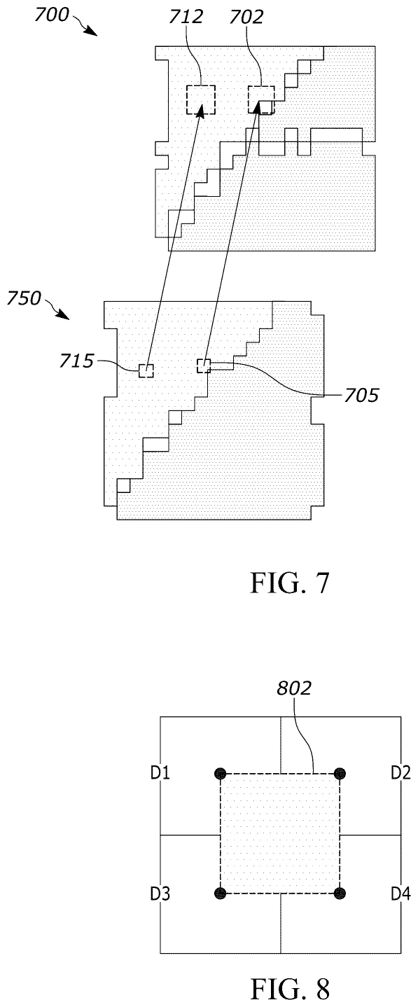

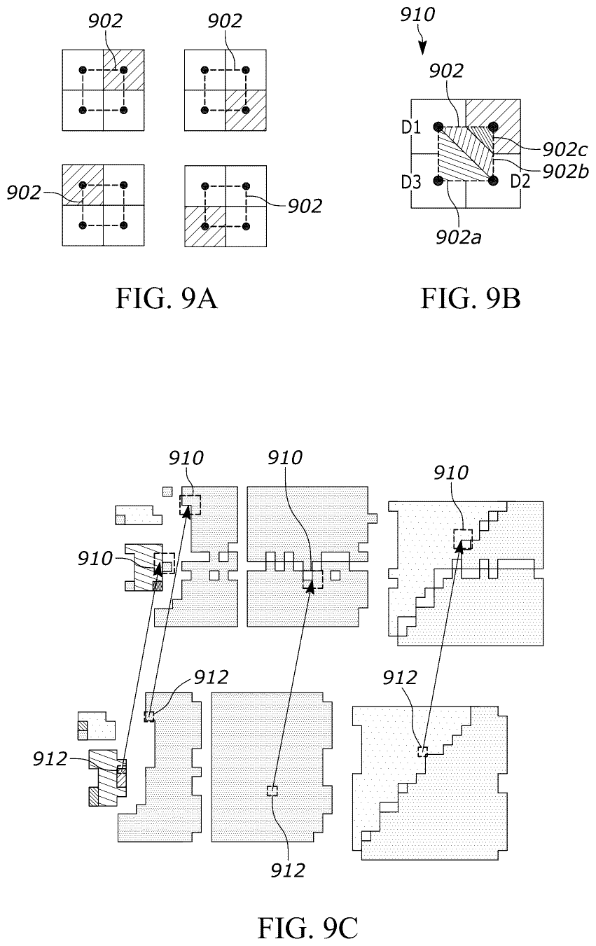

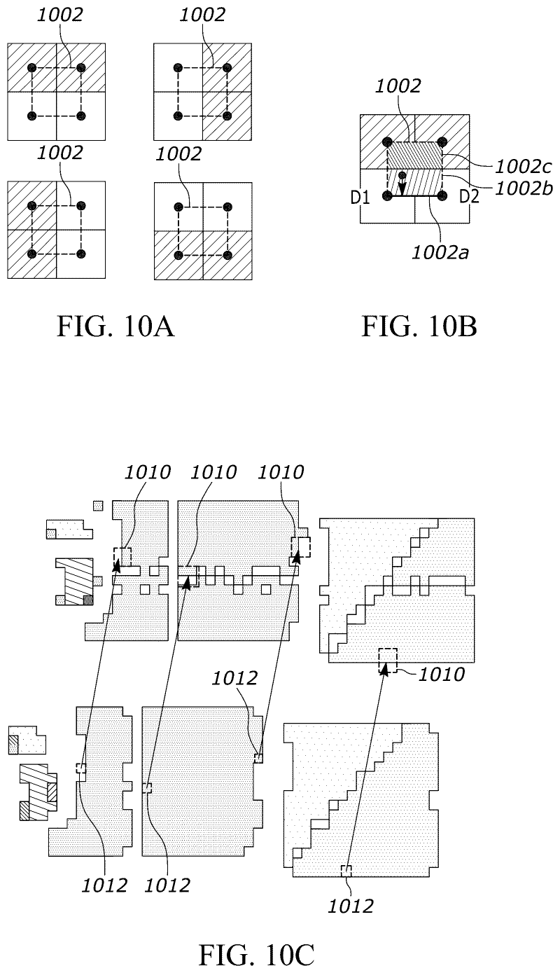

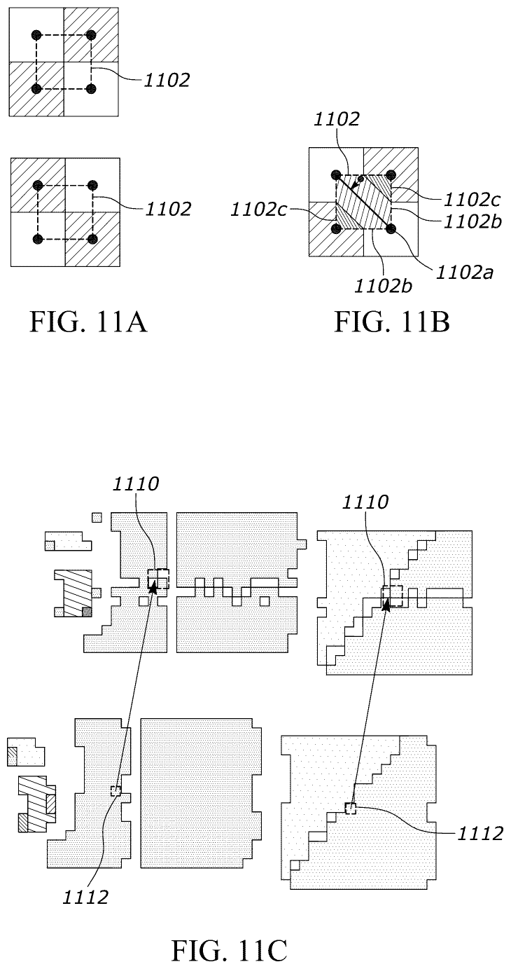

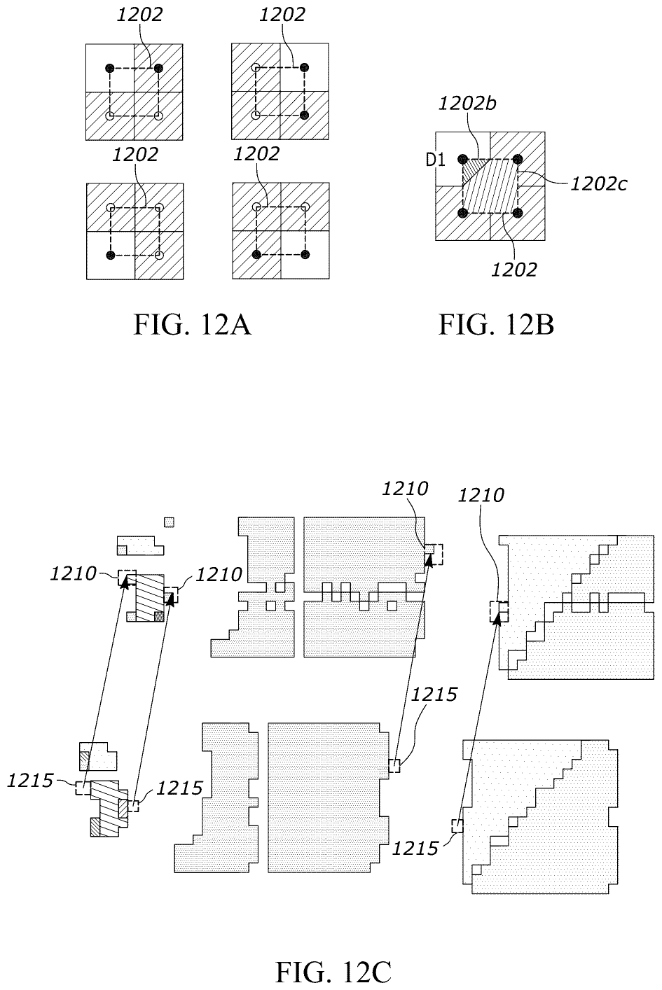

The pixel neighborhood may include various pixel configurations for each respective mapped pixel. For example, the pixel neighborhood may be a 2 by 2 array of four pixels. The pixel array may include four pixels with all four pixels including data, as illustrated further in FIG. 8, may include four pixels with one pixel having missing data, as further described with reference to FIGS. 9A-9C, may include four pixels with two pixels having missing data, as described with respect to FIGS. 10A-11C, or may include four pixels with three pixels having missing data, as described with reference to FIGS. 12A-12C. Each individual pixel neighborhood is used to determine how the missing pixel data is to be reconstructed for the warped image, as will be described below with respect to FIGS. 8-12C. The data of the pixels, and missing data of pixels, in a given pixel neighborhood is used together to determine respective mapped pixel values.

At block 508, the processor then determines a mapped pixel value for each mapped pixel from the respective identified pixel neighborhood configurations, and interpolations or extrapolations of pixels values from the respective pixel neighborhoods of the first image. The mapped pixel value may be determined from a sub-pixel location in the determined pixel neighborhood. For example, the mapped pixel value may be determined to be different if the mapped pixel value is to be taken from the middle of a pixel of the pixel neighborhood, or from a corner of a pixel from the pixel neighborhood. As such, in examples, the mapped pixel value for generating a warped image, and performing image data reconstruction, depends of the sub-pixel location in the pixel neighborhood of the first image.

In the provided examples, a sub-pixel region within the pixels of each neighborhood of pixels is used to determine mapped pixel values from specific mapping locations within the sub-pixel region. The sub-pixel region in each pixel neighborhood may be divided into separate sub-regions that indicated whether a mapped pixel value is determined as a nearest pixel data value (e.g., the mapped value is determined as the value of the pixel that is closest to the location or position in the sub-pixel region that the mapped value is to be taken from, or set to the value of the pixel that the mapped position is determined from in the first image), an interpolation of pixel data values in the pixel neighborhood, an extrapolation based on pixel data values in the pixel neighborhood, or an invalid or missing data value.

The processor then generates a warped image from all of the mapped pixel values, and presents the warped image to a user at 510. The processor may present the image via one or more displays, touch screen devices, computers, user interfaces or other systems. Further, the processor may further perform additional image processing on the warped image or may perform machine vision processes using the warped image. The processor may store the warped image in a memory for further retrieval or providing to additional systems and networks.

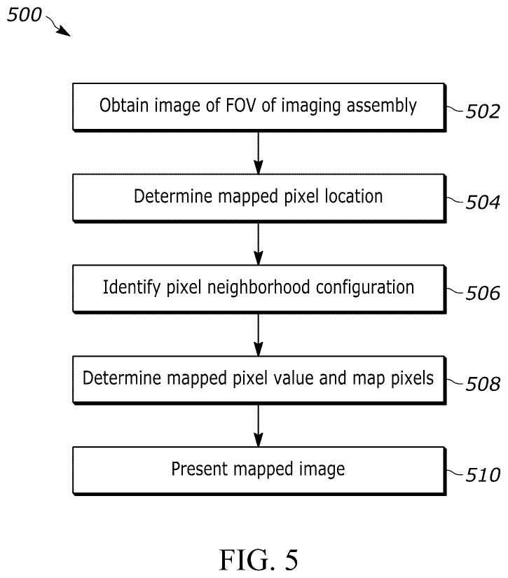

FIG. 6 is a flowchart of a method 600 for performing data reconstructive image warping, as may be performed entirely or as part of the warping application of FIG. 1. At 602, the method 600 includes capturing a first image of a first FOV by a first imaging assembly, and a second image of a second FOV by a second imaging assembly, as may be performed by the two imaging assemblies 104a and 104b of the example of FIG. 4B. The imaging devices capture images with one or more targets, or objects of interest, being disposed in the FsOV of the imaging devices. In examples, the imaging systems may independently include one or more of an infrared camera, a color camera, two-dimensional camera, a three-dimensional camera, a handheld camera, or a plurality of cameras.

The first and second FsOV may include portions that overlap, or may substantially captured a same region of the scanning surface 303 of FIG. 4B, or substantially similar objects or targets of interest. The two imaging systems may have FsOV that are at different angles and therefore may capture images of objects at different vantage points of perspectives. As such, images captured by the first and second imaging systems may include pixels having missing data at different areas or regions of the captured images. For example, in a 3D image, an image captured by the first imaging assembly may have voxels that are missing data due to one or more objects obstructing the view of the first imaging assembly, while the second imaging assembly is positioned such that corresponding voxels missing data in the first image are apparent and include data in the second image. As previously discussed, the first image may be obtained using a first imaging device having a first FOV, and the second image may be obtained using a second imaging device having a second FOV that is different than the first FOV. In examples, the first and second images may be obtained using a single imaging device, with the imaging device being at different positions while obtaining the first and second images resulting in the first image providing a first perspective of the target and the second image providing a second, different, perspective of the target. As such, the first and second images are obtained at different FOVs or physical perspectives of the target.

The processor may then determine an image mapping of the second image to the first image FOV at 604. The mapping from the second FOV to the first FOV may be a known transformation or mapping, or the processor may identify one or more features from the obtained first and second images to determine the transformation from the second FOV to the first FOV. At 606, the processor determines mapped pixel locations for generating a warped image of the second image according to the determined image transformation. The processor then determines a pixel neighborhood and identifies a pixel neighborhood configuration in the second image at 608. As further described herein, each pixel neighborhood is used to determine the value of one or more mapped pixels, and for performing data reconstruction of pixels having missing data, in performing warping of images.

The pixel neighborhood may include various pixel configurations for each respective mapped pixel. For example, the pixel neighborhood may be a 2 by 2 array of four pixels. The pixel array may include four pixels with all four pixels including data, may include four pixels with one pixel having missing data, may include four pixels with two pixels having missing data, or may include four pixels with three pixels having missing data. Each individual pixel neighborhood configuration is used to determine how the missing pixel data is to be reconstructed for the warped image, as described below with respect to FIGS. 8-12C.

At block 610, the processor determines a mapped pixel value for each mapped pixel from the respective identified pixel neighborhood configurations, and interpolations or extrapolations of pixels values from the respective pixel neighborhoods of the first image. The mapped pixel value may be determined from a sub-pixel location in the determined pixel neighborhood. For example, the mapped pixel value may be determined to be different if the mapped pixel value is to be taken from the middle of a pixel of the pixel neighborhood, or from a corner of a pixel from the pixel neighborhood. As such, in examples, the mapped pixel value for generating a warped image, and performing image data reconstruction, depends of the sub-pixel location in the pixel neighborhood of the first image.

The processor then generates a warped image from all of the mapped pixel values of the second image and presents the warped image to a user at 612. The processor may present the image via one or more displays, touch screen devices, computers, user interfaces or other systems. Further, the processor may further perform additional image processing on the warped image or may perform machine vision processes using the warped image. For example, the processor may perform image stitching or combining of the first image and the warped image of the transformed second image to generate and present a composite or stitched image of the first and second images. Additionally, the processor may store the warped image, or composite image of the first image and warped second image, in a memory for further retrieval or to provide to additional systems and networks.

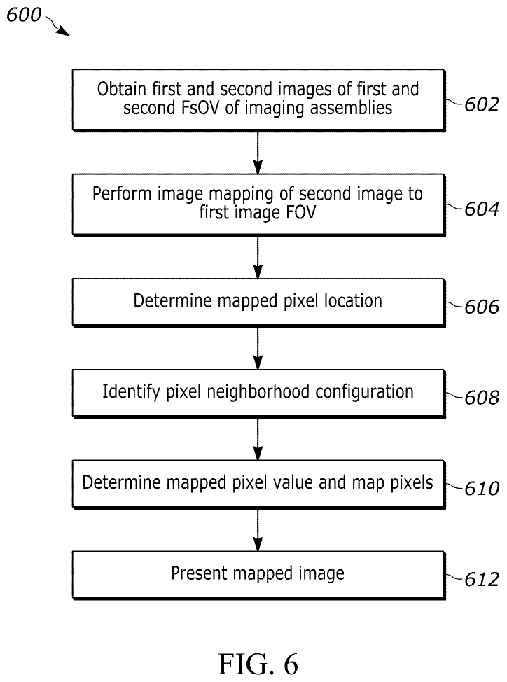

FIG. 7 is an example image 700 including a plurality of pixels to demonstrate the described methods of image warping and data reconstruction described herein. The image of FIG. 7 includes pixels having data (shaded pixels, and pixels without data (white pixels). FIG. 7 also includes a generated warped image 750 generated using the methods described herein, the warped image generated by determining pixel data from neighborhoods of pixels of the first image 700. FIG. 7 illustrates two resulting mapped pixels 715 and 705 with data determined from respective pixel neighborhoods 712 and 705 of the first image 700. The pixel neighborhood 712 includes four pixels each containing image data, and the pixel neighborhood 702 includes four pixels with two pixels missing data. The various pixel neighborhoods, and reconstructing data from pixel neighborhoods is described further with respect to FIGS. 8-12C.

FIG. 8 is an example pixel neighborhood of four pixels D1-D4, with each pixel having image data. A pixel data value for a mapped pixel may be determined from a region 802 with vertices at the centers of each of the pixels D1-D4. For the example with each of the four pixels containing image data, the region 802 may be defined to provide a mapped pixel value as determined by an interpolation between the various pixel values of the pixels D1-D4. For example, the value of the region 802 to provide as a mapped pixel value, may be determined as a bilinear interpolation of the data values of the pixels D1-D4 across the region 802. As such, values of the mapped pixel value with an inverse transformation sub-pixel location in the first image lies in region 802 may vary across the region 802 depending on its sub-pixel location in the region 801, and a mapped pixel value may be determined by a sub-pixel location in the region 802. In some embodiments, the mapped pixel value may be determined as the value of the pixel with a center closest to the determined sub-pixel location in the first image of the mapped pixel. The mapped pixel value may also be determined as a pixel data value of the pixel that the determined sub-pixel location is in, or a nearest neighbor pixel to the location of the determined sub-pixel location. It should be noted, that the region 802, in the provided examples, is defined by the centers of multiple pixels, and therefore, includes sub-pixel locations of four different pixels in the pixel neighborhood.

FIG. 9A provides four different neighborhood configurations with one of four pixels missing data. The missing data pixels are indicated as the pixel in each neighborhood having diagonally striped lines. As previously described with respect to FIG. 8, a region 902 may be defined by the centers of each of the pixels. The region 902 may be divided into three separate areas 902a-902c for determining a mapped pixel value for performing image warping. FIG. 9B illustrates different regions for determining a mapped pixel values for the neighborhood configurations having one missing pixel value. The central region 902 for determining a mapped pixel value may be separated into three distinct regions including a first region 902a, second region 902b, and third region 902c. The first region 902a may be defined by the three central points of the pixels having data, and the second and third regions 902b and 902c may be further defined relative to the pixel that is missing data. The first region 902a may provide mapped pixel values that are determined by an interpolation of the data values of the pixels having data. For example, the interpolation for the first region 902a may be a barycentric interpolation for determining mapped pixel values across the first region 902a. The second region 902b may be determined to provide mapped pixel values according to an extrapolation, such as a barycentric extrapolation, of the data values of the pixels having data, and the third region 902c may be determined to provide mapped pixel values that are invalid or maintain a missing data value for a mapped pixel from any of the sub-pixel area of the third region 902c. As such, the mapped pixel value may be determined to be an interpolation of data, an extrapolation of data, or maintained as a missing data pixel value based on sub-pixel locations of the mapped pixel value from the region 902, and specifically from the sub-regions 902a, 902b, and 902c. FIG. 9C provides example images of pixel neighborhoods 910 that include one pixel having missing data, and further shows the mapped pixels 912 with pixel values derived from the data of the corresponding pixel neighborhoods. The arrows between the mapped pixels 912 and the pixel neighborhoods 910 show the sub-pixel regions in which the mapped pixel values were determined from in each pixel neighborhood 910. In any examples, the various regions 902a, 902b, and 902c, may be tuned to include more sub-pixel area of the region 902 to provide missing data or invalid values to mapped pixels, interpolated values from pixels, or extrapolated values from pixels.

FIG. 10A provides illustrations of four pixel neighborhood configurations that includes two pixels with missing data. The pixels having missing data are indicated as the pixels with diagonal stripes, and a region 1002 for determining mapped pixel values is defined by the centers of each pixel of the pixel neighborhood. FIG. 10B provides illustrations of different regions of the pixel neighborhood that may be used to determine mapped pixel values. The region 1002 for determining mapped pixel values may be divided into sub-regions including a first region 1002a, second region 1002b, and a third region 1002c. The first region 1002a may provide mapped pixel values that are taken in a small area, or a border, defined between the centers of the two pixels having data. Mapped pixel values provided by the first region 1002a may be determined by an interpolation between the data values of the pixels having data. The second region 1002b may be defined by the area between the first region 1002a and the border of the pixels having missing data. The mapped pixel values provided by the second region may be determined by a line interpolation of a projected pixel. Mapped pixels that are mapped from the third region 1002c may be assigned a value of invalid or missing data, and the third region may be defined as a sub-region entirely in the pixels having missing data. FIG. 10C provides example images with pixel neighborhoods 1010 having two pixels with missing data, and associated warped images with pixels 1012 showing reconstructed data using the mapped pixels from the sub-pixel locations of the region 1002a, 1002b, 1002c. In the provided examples of FIG. 10C, some of the mapped pixels 1012 include pixel data, and other mapped pixels 1012 may be determined to be pixels with missing data. In any examples, the various regions 1002a, 1002b, and 1002c, may be tuned to include more sub-pixel area of the region 1002 to provide missing data or invalid values to mapped pixels, interpolated values from pixels, or extrapolated values from pixels.

FIG. 11A provides illustrations of two different pixel neighborhood configurations with to pixels having missing data that are diagonally opposite each other in the pixel neighborhood, as indicated by the pixels having diagonal lines in each pixel neighborhood. Each pixel neighborhood includes a region 1102 for determining mapped pixel data, the region 1102 being defined by the centers of each pixel of the pixel neighborhoods. The region 1102 may be divided into three sub-regions for determining mapped pixel values from sub-pixel areas of the region 1102. FIG. 11B provides one example of various sub-regions of the region 1102 that may be used to determine mapped pixel values from the pixel neighborhood. The sub-regions may include a first region 1102a, second region 1102b, and third region 1102c. The first region 1102a may be defined as the line segment, or an area around the line segment, between the centers of the pixels having data. Mapped pixel data values of the first region 1102a may be determined by a line interpolation of the data values of the two pixels having data. For example, the mapped pixel data values of the second region 1102b may be determined by a line interpolation of projected values derived from the data of the two pixels having data. Further, the second region 1102b may be defined relative to the first region 1102, and a distance from the centers of the pixels having missing data. The third region 1102c may be determined to provide mapped pixel values having an invalid value or missing data. The third region may be defined by the centers of the pixels having missing data, and a border based on a relative distance from the first region 1102a. FIG. 11C provides images with pixel neighborhoods 1110 used to determine mapped data pixel values for mapped pixels 1112 or warped images. The pixel neighborhoods 1110 of FIG. 11C each include two pixels having missing data in a diagonal configuration, as illustrated in FIGS. 11A and 11B. The arrows provided from the mapped pixels 1112 to the pixel neighborhoods indicate the sub-pixel area that the mapped pixel data was determined from in each pixel neighborhood 1110. In any examples, the various regions 1102a, 1102b and 1102c, may be tuned to include more sub-pixel area of the region 1102 to provide missing data or invalid values to mapped pixels, interpolated values from pixels, or extrapolated values from pixels.

FIG. 12A provides illustrations of four different pixel neighborhood configurations having three pixels with missing data, as indicated by the pixels with diagonal stripes. Each pixel neighborhood includes a region 1202 for determining mapped pixel data, the region 1202 being defined by the centers of each pixel of the pixel neighborhoods. The region 1202 may be divided into two sub-regions for determining mapped pixel values from sub-pixel areas of the region 1202. FIG. 12B provides one example of sub-regions of the region 1202 for determining mapped pixel values. The sub-regions may include a first region 1202b, and a second region 1102c. The first region 1202b may be defined by the center of the pixel having data, and a relative distance away from the center of the pixel with data, toward the pixels having missing data. The second region 1202a may provide mapped pixel data values at a set value based on the data of the singular pixel with data in the pixel neighborhood configuration. The second region 1202c may be defined by the centers of the three pixels with missing data, and may provide an invalid or missing value for the mapped pixel data. The various regions may be tuned to include more sub-pixel area of the region 1202 to provide missing data or invalid values to mapped pixels, interpolated values from pixels, or extrapolated values from pixels. FIG. 12C provides images of pixels with pixel neighborhood configurations 1210 with three pixels having missing data, and respective mapped pixels 1215 with pixel data determined according to the methods described herein. The arrows from the mapped pixels 1215 of the warped images, to the pixel neighborhood configurations 1210 of the original images point to the sub-pixel area that each mapped pixel value was derived from. As evidenced from the mapped pixels 1215 of FIG. 12C, some of the determined values are invalid or missing, as described in the example of FIG. 12B.

In any of the example pixel neighborhood configurations of FIGS. 8-12C, the various sub-regions for determining mapped pixel values may be defined in various ways according to vertices, centers, or edges of pixels. Additionally, the above descriptions of the specific determinations of pixel values is one examples. The mapped pixel values may be determined for any regions or sub-pixel locations according to interpolations of pixel data, extrapolations of pixel data, nearest neighbor pixel values to determined sub-pixel locations, data values of pixels that contain the sub-pixel locations, or determined as invalid of missing based on sub-pixel locations in pixel neighborhoods, and based on specific pixel neighborhood configurations.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions.

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

We claim:

1. A method for performing image warping, the method comprising:
obtaining, by a first imaging assembly having a first field of view, a first image of one or more objects in the first field of view, the first image including one or more pixels having missing data pixel values;
determining, by a processor, a mapped pixel location for each pixel of the first image;
identifying, by the processor, a pixel neighborhood having a pixel neighborhood configuration for each mapped pixel location;
determining, by the processor, a mapped pixel value for each mapped pixel, each mapped pixel value based on the pixel neighborhood configuration; and
presenting an image of the mapped pixels and mapped pixel values to a user.

2. The method of claim 1, wherein each mapped pixel value is determined as one of (i) an interpolation of pixel values in the pixel neighborhood, (ii) an extrapolation of pixel values in the pixel neighborhood, or (iii) a missing data pixel value, based on the pixel neighborhood configuration.

3. The method of claim 1, wherein the mapped pixel location of each mapped pixel is a sub-pixel location of a respective pixel neighborhood for each pixel.

4. The method of claim 3, wherein each mapped pixel value is further determined based on the sub-pixel position of each mapped pixel in each respective pixel neighborhood.

5. The method of claim 1, further comprising:
obtaining, by a second imaging assembly having a second field of view, a second image of one or more objects in the second field of view;
determining, by the processor, a mapped pixel location for each pixel of the second image;
identifying, by the processor, a pixel neighborhood having a pixel neighborhood configuration for each mapped pixel location; and
determining, by the processor, a mapped pixel value for each mapped pixel, each mapped pixel value based on the pixel neighborhood configuration.

6. The method of claim 5, further comprising transforming, by a processor, the second image according to the first field of view of the first imaging assembly.

7. The method of claim 1, wherein the first imaging assembly comprises a two-dimensional camera.

8. The method of claim 1, wherein the first imaging assembly comprises a three-dimensional camera.

9. A system for performing image warping, the system comprising:
a first imaging assembly having an imaging sensor configured to capture images of a first field of view; and
one or more processors and machine readable instructions that when executed by the one or more processors cause the system to:
obtain a first image by the first imaging assembly of one or more objects in the first field of view, the first image including one or more pixels having missing pixel data,
determine a mapped pixel location for each pixel of the first image,
identify a pixel neighborhood having a pixel neighborhood configuration for each mapped pixel location,
determine a mapped pixel value for each mapped pixel, each mapped pixel value based on the pixel neighborhood configuration, and
present an image of the mapped pixels and mapped pixel values to a user.

10. The system of claim 9, wherein the mapped pixel value is determined as one of (i) an interpolation of pixel values in the pixel neighborhood, (ii) an extrapolation of pixel values in the pixel neighborhood, or (iii) a missing data pixel value, based on the pixel neighborhood configuration.

11. The system of claim 9, wherein the mapped pixel location of each mapped pixel is a sub-pixel location of a respective pixel neighborhood for each pixel.

12. The system of claim 11, wherein each mapped pixel value is further determined based on the sub-pixel position of each mapped pixel in each respective pixel neighborhood.

13. The system of claim 9, further comprising a second imaging assembly having an imaging sensor configured to capture images of a second field of view, and wherein the machine readable instructions, when executed by the one or more processors, further cause the system to:
obtain a second image by the second imaging assembly of one or more objects in the second field of view,
determine a mapped pixel location for each pixel of the second image,
identify a pixel neighborhood having a pixel neighborhood configuration for each mapped pixel location of the second image, and
determine a mapped pixel value for each mapped pixel of the second image, each mapped pixel value based on each respective pixel neighborhood configuration.

14. The system of claim 13, wherein the machine readable instructions, when executed by the one or more processors, further cause the system to transform the second image according to the first field of view of the first imaging assembly.

15. The system of claim 9, wherein the first imaging assembly comprises a two-dimensional camera.

16. The system of claim 9, wherein the first imaging assembly comprises a three-dimensional camera.

17. One or more non-transitory computer-readable media storing computer-executable instructions that, when executed via one or more processors, cause one or more systems to:
obtain a first image of one or more objects in a first field of view, the first image including one or more pixels having missing pixel data;
determine a mapped pixel location for each pixel of the first image;
identify a pixel neighborhood having a pixel neighborhood configuration for each mapped pixel location;
determine a mapped pixel value for each mapped pixel, each mapped pixel value based on the pixel neighborhood configuration; and
present an image of the mapped pixels and mapped pixel values to a user.

18. The computer-readable media of claim 17 wherein the mapped pixel location of each mapped pixel is a sub-pixel location of a respective pixel neighborhood for each pixel.

19. The computer-readable media of claim 18, wherein each mapped pixel value is further determined based on the sub-pixel position of each mapped pixel in each respective pixel neighborhood.

20. The computer-readable media of claim 17, where the first image comprises a three-dimensional image.
